(19) United States
(12) Patent Application Publication
(10) Pub. No.: US 2007/0022066 A1
(43) Pub. Date: Jan. 25, 2007

(54) COMPUTATIONAL INTELLIGENCE SYSTEM

(76) Inventors: Elizabeth J. Goldstein, Carlisle, PA (US); Larry Spence, Bellefonte, PA (US)

Correspondence Address: BELL, BOYD, & LLOYD LLC, P. O. BOX 1135, CHICAGO, IL, 60690-1135, US

(21) Appl. No.: 11/279,536

(22) Filed: Apr. 12, 2006

Related U.S. Application Data
(60) Provisional application No. 60/670,463, filed on Apr. 12, 2005.

(51) Int. Cl. G06F 15/18; G06E 1/00

(52) U.S. Cl. 706/20

(57) ABSTRACT

A method of computational intelligence is disclosed.

### BACKGROUND OF THE INVENTION

The invention relates to methods and means for knowledge, data and information management as compared to data mining, for example.

### SUMMARY OF THE INVENTION

The invention relates to a collection of computational tools to manage knowledge, data and information. The tools enable categorization and forecasts. The tools enable a real time reassessment of parameters, assumptions and results, for example.

Additional features and advantages of the present invention are described in, and will be apparent from, the following Detailed Description of the Invention and the figures.

### BRIEF DESCRIPTION OF THE FIGURES

FIG. 1 depicts a schematic of the producer paradigm.

FIG. 2 is a flow diagram of a category.

FIG. 3 provides a block diagram of a forecast.

FIG. 4 depicts a process yielding a preference.

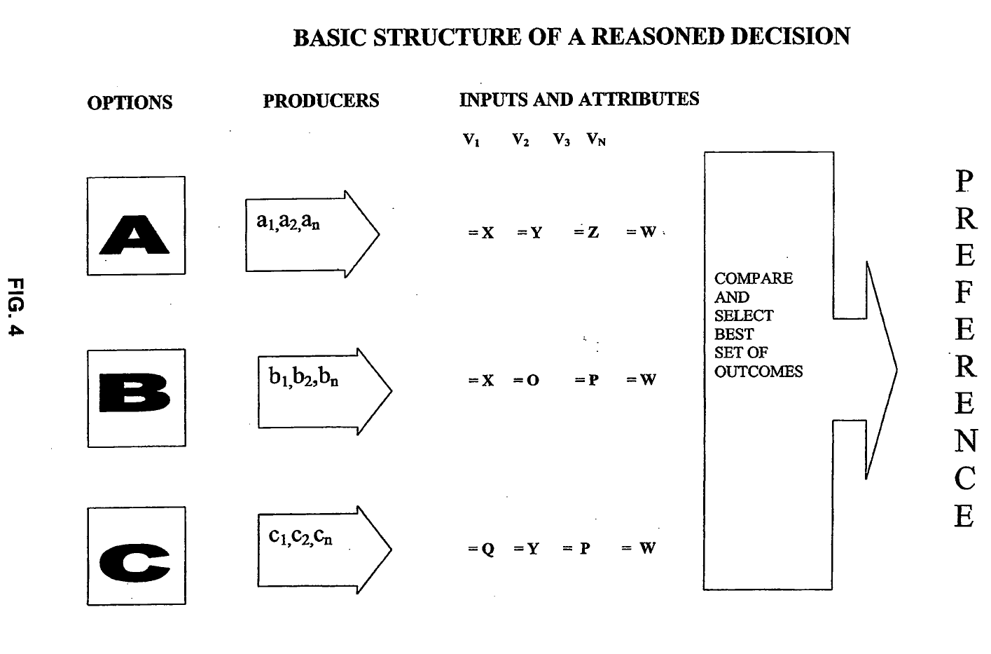

### DETAILED DESCRIPTION OF THE INVENTION

The invention relates to a method and relevant tools for efforting “computational intelligence.”

Knowledge is a simplification of experience. Whenever one changes their mind, knowledge and information are being managed.

The invention relates to a series of decision trees, subroutines and modules inquiring about what knowledge should be discarded, kept, changed, borrowed, or created.

Knowledge must be managed because our knowledge tools change. Each year brings a myriad of new instruments and new capacities. The present looks less and less like the past and knowledge grows obsolete. Intellect, long adapted to form and to retain generalizations about the world, now can be a hurdle to evaluating and improving new facts. Luckily, intellect is an efficient learning machine that can seize on failures to better understand. The human condition in a rapidly changing environment demands that what is learned must be systematically catalogued, critiqued, and tested as compared to general patterns, assumptions and trends.

There is a need to articulate knowledge, to evaluate knowledge, to improve knowledge, and to use knowledge with some sense of the risk involved.

This is an age of information, and knowledge is the most important element of survival and success. Computing and information transmitting tools that give access to the knowledge and accumulated wisdom are available.

Ideas about knowledge management and computational intelligence have not caught up to the current and developing informational environment. Despite the information and knowledge at hand, so much is not used or is ill used. Too often actions are based on the last recollection, on memories of a normal course of action, on irrational bases, and so on. An Ernst and Young survey of 431 firms found that most knowledge management efforts consisted of storing knowledge in data warehouses and intranets, building networks for people to find experts and developing technologies and strategies to facilitate collaboration. Those efforts emphasize technology to store and to transfer information and data about production, sales, costs and visions.

Useful tools help create systems, edifices, and social networks of amazing complexity. The same applies for knowledge management and computational intelligence. A small kit of intellectual tools that are versatile can adapt and improve knowledge metabolism.

Eugene Meehan suggests we think of the human knowledge management problem as walking through life backwards.

However, the focus should be on the future. As a starting point, there is experience—actions, results, events, contingencies, and objects. Experience is turned into simple patterns used to anticipate, to make things happen, and to choose a best course of action to pursue.

Consider knowledge as a collection of generalized patterns. Patterns are intuited and spontaneously created, modified, and discarded. During ontological development, objects are differentiated and categories are created. Objects in the environment are sorted and attributes thereof generalized. Patterns of relationships are then developed based on the acquired knowledge.

Such patterns bridge the gap between the experience of the past and the desires of the future. The same patterns help test and improve. If there are categories for mom, dad, stuffed bears, and frogs, experience and observations can be obtained, kissed dad, hid from mom, lost a bear, and heard frogs in the backyard. Such descriptions are “information” to be differentiated from knowledge.

Information is about objects and events at a certain time and place. Knowledge is about patterns that hold without regard to time and place. Information is relatively certain. If one were told there are three elephants in the side yard, that is amenable to direct confirmation. Information can be considered a fact, such as Moscow is the capital of Russia or the Mississippi River is in North America. Facts seem solid, confirmable and able to be evaluated.

But information can have little value without knowledge. Data are solid enough to be treated as objects that can be transported, stored, and sorted. Data can be certain, either right or wrong. Data is often useless without the abstract patterns of information and knowledge. Data will be treated as numbers and images of things and events. The category, elephant, is knowledge. The report of elephants in the yard is information. The images of elephants and the number of elephants are data.

Knowledge management or computational intelligence can be defined by dividing experience into those types:
Knowledge consisting of generalized patterns of objects, events and relations.
Information consisting of descriptions of events, objects, and relations using the patterns called categories (which includes relations).
Data consisting of images and numbers.

Most computational intelligence techniques focus on information and data, because such are more concrete, easily observed, stored, and reported. If someone says that Judy Ontology is an intelligent, industrious student, that knowledge seems like an opinion. If we report the information “Judy scored 1492 on her SATs,” that looks certain. The datum “1492” seems precise and objective. The information or the data alone can be without context and reference. What is needed is something that can guide actions regarding Judy. Only the generalized pattern “Judy is an intelligent . . . etc.” is useful because it summarizes a lot of information about Judy in a form that helps make predictions about her future performance. Of course, the pattern is based on information and data like her SAT scores, her high school grades, and her achievements. Without such information it would indeed be just a risky opinion. The information gives evidence of reliability. Knowledge provides greater context and hopefully reduces uncertainty.

An aversion to the uncertainty of knowledge leads to gathering information and data in an attempt to achieve certainty. All know the problems of paralysis by analysis and sprawling warehouses of facts beyond control or understanding. Today organizations spend billions on software trying to make their piles of information and data usable. Ironically, in trying to avoid the uncertainty involved in using knowledge, the means of confusion are proliferated.

Think of knowledge as a way of both creating and storing information and data. A helpful analogy is to consider knowledge as a series of containers and information as what is stored in the containers. Up close, the information and data are all around us. Only when a step is taken in abstraction can the boxes, jars, and folders, labeled knowledge, information, and data, respectively, be seen. Now imagine the same collection without the containers. The resulting chaos is the major problem of knowledge management.

The knowledge containers are tools for organizing, storing, testing and using information and data. The tools are abstractions to help create, test and reuse knowledge. There are at least six types of generalized patterns. A taxonomy of the computational intelligence tool kit comprises:
Categories (names and definitions of events and things like rocks, throwing, and elections plus relations like beside, causes, or makes);
Governing Categories (conditions of life like health, freedom, and safety);
Forecasts (relations and trends that hold over time like the occurrence of winter and snow);
Producers (actions that regularly cause results like advertising campaigns or rewards);
Guidelines (preferences that hold over time like always opting for the high ground in battle); and
Policies (action plans like how to pick an amusing DVD at the video store).

How does computational intelligence operate?

Every action produces results, which when compared with intentions gives a measure of the reliability of our mental models of the world. The sequence of application is: select a purpose, find or create an appropriate pattern for that purpose, assume a situation fits the pattern, justify the use of the instrument based on past experience, then apply the pattern and use the results to test the tool, to diagnosis of the situation, and to assess the adequacy of information. Failure all or in part is a spur to improvement.

That series of conceptual steps is taken all of the time, but only rarely and in times of trouble is the process inspected. Such an inspection requires a typology of tools plus their structure, nature, limitations, uses etc. By practicing the use of these abstractions, the process can be made transparent and subject to improvement through research and analysis prior to action. For example, every action is based on a set of patterns. One is moved to action by anticipation of the future based on categories and forecasts. One can act according to productive causal patterns. One selects which action to pursue based on governing values, guidelines and policies. All of these patterns depend on the quality of descriptions based on the categories. Once one is comfortable manipulating the patterns, experiences can be sampled and intuition can be tested to act with more reliability and with more likely results.

The key to computational intelligence is mastery of the toolbox such that information and data can be collected, labeled, sorted, stored and retrieved according to the defined needs to correct and to expand knowledge. Learning from mistakes thus becomes a productive process which promotes the wisdom of understanding, the limitations of knowledge without despair. It goads to strive to improve without hubris.

Each type of pattern has distinctive characteristics, which enables an evaluation of reliability and relevance. Reliability is an estimate of the quality of experience contained in the pattern. For example, consider a fictional creature called a “woggle.” That one time observation will yield a pattern. That pattern will contain attributes—a thin spiny creature with six legs and three large eyes. But one observation will not provide information on all woggles. Several encounters with woggles, particularly under different times and places, will increase the details until it will be possible to anticipate where woggles are likely to be found, if they can be eaten, what they eat, and the noises they make when mating, for example. One can then identify a woggle with some ease, tell stories about them, protect them, and use them to reduce the slugs in our garden, for example. The category, woggle, is now reliable and useful, which are relative terms as that does not mean learning more about woggles will cease. For example, the definition may need alteration if an Australian animal similar to an American woggle is found to have four eyes.

Knowledge depends on categories. They are the most basic tools to create and to collect information. When categories are elaborated, the categories can be used to anticipate the future and when combined, can create the causal patterns that guide actions. So basic are categories that categories often escape attention. Consider how infants learn their world. They have to discriminate among people, things, and animals. They must identify specific mommas, daddies, teddy bears and Gizmo the cat. Once infants create patterns, an infant can expect what will happen and use failures to improve categories or make new ones. They quickly know that tables are solid, water is not, Daddy protects me, Henry does not, Pooh Bear is a stuffed toy and Clarence the dog is not. These patterns guide actions—babies “learn” not to stuff their heads in tables and soon realize that to squeeze Gizmo is to risk a bite. Their world makes sense as infants expect things to happen and use failures to improve.

One of the most important types of patterns is a producer. Many producers have a long history and so, are employed automatically and mindlessly. Thus, they might not be considered unreliable. One can get in the rut of taking action again and again with poor results thinking that any lack of success results from bad luck or some other subjective variable or intangible. Consider some of these patterns in common use:
High temperatures kill bacteria.
Low temperatures impede bacteria growth.
Attractive appearance makes relations work better.
A good reputation attracts loyalty.
Less house dust means fewer allergy problems.
Arriving late for work damages your reputation as an employee.
The higher the speed of an automobile the longer distance required to stop.

Based on that knowledge, food is cooked, leftovers are refrigerated, showers are taken and hair is styled, attempts are made to meet obligations, the house is vacuumed, alarms are set to arise from bed on time and a safe distance is kept from the car in front. All of those patterns have the same structure and the same reliability requirements.

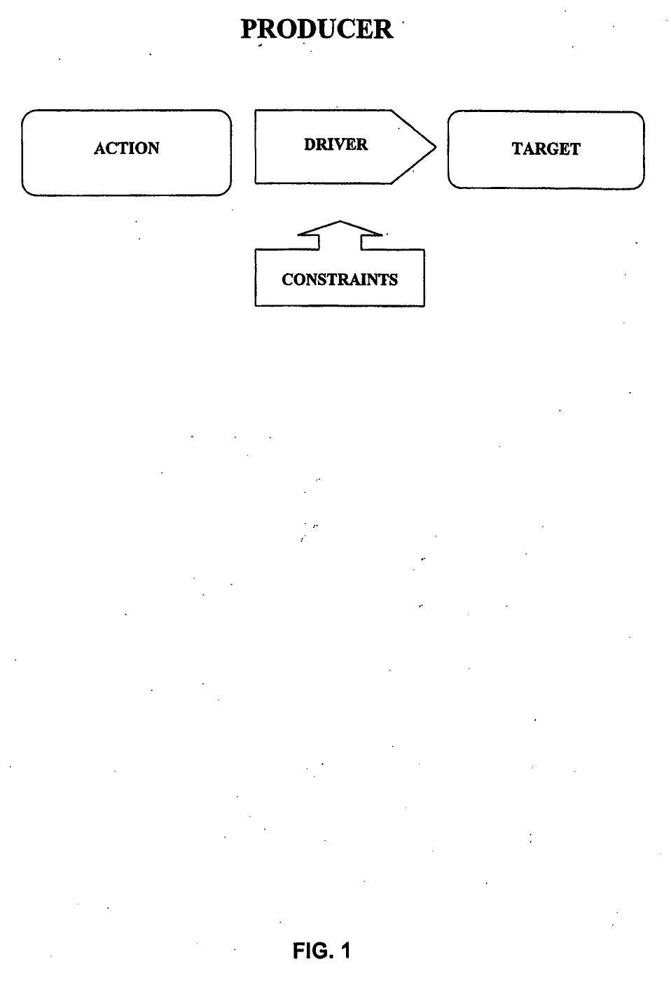

A producer (FIG. 1) links two sets of categories with a causal rule such that a change in one set will cause a change in the second—if certain constraints or conditions are heeded. The variable that can change is called the Action. The category or variable to change is called the Target and the causal rule is called the Driver. Constraints are necessary because the world is so complex, with so many events affecting affairs that Producers do not always operate or occur.

The knowledge guiding everyday actions can be broken down into the parts of the paradigm of FIG. 1. That can help locate defects. For example, since Actions are formed from categories, poorly defined categories can yield undesirable actions.

Once the structure and requirements of a Producer are understood, failure can trigger a checklist of probable faults. That is an advantage that can help learning more quickly and with less risk of disaster. The same checklist can yield an evaluation of the claims of experts. Take the three elements of the tool—action, driver and target. The action has to be something that can be accomplished. In the famous story, the mice came up with a great producer, “Put a bell on the cat that warns us in time to escape.” It was useless because the mice had no way to bell the cat.

The driver has to be stated with as much precision as possible.

Finally the target has to be something wanted. Nothing is harder than finding out what is wanted and nothing is a better device for creating, testing and improving your knowledge. Comparing the results of actions with desires provides an incentive to unmask assumed patterns and to improve beliefs. When one acts—buys a car, selects a college, takes a new job, or sells a mutual fund—a choice of one over others is being made.

Dozens of choices are made everyday. Most are “automatic,” from picking out the proper shoes from the closet to going jogging. Some are more deliberate, such as dressing for a job interview. A few are more complex, choosing a college to attend, buying a house or selecting a vocation. In the worlds of politics, business, technology and scientific research, choices are even more complex involving many options, variables, and trade-offs plus mountains of data and information to consider.

There may be insufficient time, information and knowledge to make fully rational choices. The best decision under the circumstances is made with a mental note to learn from the experience. As many wise people have pointed out, experience does not teach. To learn from experience, the knowledge and principles involved in the choices must be explicit and precise.

To do that, options are created or found—actions that can be taken at this time and place. Then important features that will be changed by the options are selected or created. One projects changes on those features that each line of action will make and one decides which is most likely to produce the best set of results.

When that paradigm is not heeded, one experiences, but does not learn. For example, an obese person wanted to buy a bicycle because that person thought riding would help keep one in shape. Everyone talked about mountain bikes. When a friend recommended a sale at a sporting goods outfit for an inexpensive mountain bike model that was selling for $100 off, the party liked the price, loved the determined ruggedness of the black frame, took it for a short spin and bought it.

The more the bike was ridden, the less desirable it became. The seat caused pain after a few miles. Hands went numb on the handlebars. Every outing of any length was excruciating. The rider rode less, did not look lean, and the rider did not feel younger. But it should have been known that a mountain bike is designed for off road riding, not touring on asphalt which was the primary use by the rider. Clearly, the choice was a disaster. A mountain bike was not for the rider. It was a bad experience and no clues were obtained about how to improve.

How can computation intelligence improve decisions? The standard approach to decisions prescribes that all of the information is amassed, alternatives weighed, and the optimal choice calculated with, for example, statistical software. However, there is often too much information and too little time.

According to the invention, to consider one type, one brand and one consequence—was economical, even if disastrous. Decisions often are made that way frequently and many turn out to be wonderful. So how can one use computational intelligence to improve decisions in real time?

Consider that decisions are fraught with emotion and emotions are a clue to simplification. If something arouses someone, that person focuses on it and ignores everything else. That works when one is trying to catch a baseball, grasp the layout of a room, or shoot skeet. Emotions help one to select cheap heuristics with which one can simplify the choice. Think of it this way, when one chooses, one is selecting a future life. That can lead to apprehension since it discloses the uncertainties one might face.

Emotionally, what the rider wanted from the purchase of a bicycle was a buffer, tougher, and, yes, younger rider. The bike was purchased for just such a possibility. Knowing what the rider wanted then was a basis for a reasoned (but perhaps not rational) decision. But a crucial part of the decision was overlooked. The bicycle would produce the leaner rider only if used. The rider did not need a bike that looked lean and mean, the rider needed a bike that was comfortable. The decision failed because the rider did not examine the knowledge that could produce the results wanted. The first step should have been to quickly find options—bicycles that might meet the standards of comfort and be affordable within shopping distance. The rider could have visited some local bike shops and tried different models. Given the available options and the primary need for usability, a better choice could have been made.

The governing categories were health and happiness. The inputs that could affect those categories were the bike features: usability, appearance, and cost. Some estimates of what impacts the options (bike models) could have been made and selected as the one most likely to produce a healthy happy life. The technique requires some inquiry, of course, but is doable. Best of all, if it fails, there are clues on how to improve.

If the bike purchased does not result in a healthier rider, that may result from three likely sources: 1) the producers used to project consequences were unreliable; 2) the action plan (policy) for locating and buying a bike that met specifications was faulty; and 3) the rider did not understand the work, pain and necessary discipline of becoming buffer and tougher. At any rate, the research and analysis can be done quickly without unrealistic requirements for global information retrieval or omniscience. Perfect decisions are not needed—just better ones.

One is always anticipating what will happen next. Friends, pets, and families can be expected to do a myriad of behaviors. Likewise, governments, communities, and business can be expected to respond in predictable ways. One can try to anticipate the weather and wear the right weight and type of clothes. The patterns underlying all of these assumptions about the future are of two types—categories, already discussed, and a new pattern forecast.

Categories guide our expectations. When many features of a category are understood, the category can be expanded into a classification. A classification consists of a definition (all of the attributes of the class with their range of values plus the meaning or the relations of the class with other categories) and a subset of identifying attributes or indicators. A breed of dog, like Dalmatian, is such a class. A dog breeder's manual can be consulted and the general characteristics of a Dalmatian, including size, shape, coloring, temperament and appearance, will be found. The appearance—or indicators—can be used to identify an animal as a Dalmatian. If correct, the remainder of the characteristics can be predicted. One can anticipate that if a Dalmatian is obtained, the owner had better be prepared to exercise it every day and that the new pet will be loyal and friendly.

The most recognized way of anticipating the future is to forecast. When pharaohs ruled Egypt, they built a temple in the Sudan at the point where three streams meet to form the Nile River. The river flowed one thousand miles to flood the lands of Egyptian farmers. Those floods allowed crops to grow in the arid hot days of summer.

Every spring, the temple priests would check the color of the water. Each river produced a different color and the dominance of one could predict the type of flood the farmers could expect. If it were clear, the flood would be mild, and late. If the stream were dark, the flood would rise enough to saturate the fields and provide a bountiful harvest. Finally, if the stream were green-brown then the floods would be early and high. Crops might drown and the Pharaoh might have to use his grain stores to feed the people.

Those ancient forecasters created a generalized pattern that linked the color of the Nile to types of floods with rules based on past history. Their pattern has the same structure as a producer—two sets of categories (variables) linked by a rule—but unlike a theory, causality is not assumed. If one were to deliberately change the color of the waters, that would not change the type of flood. A forecast cannot be tested experimentally by changing the value of the cue. One must accept or reject according to the track record. More easily constructed than producers, of more dubious reliability, forecasts are powerful intellectual tools for anticipating the future.

The key is generalization. By assuming that the patterns hold for all times and places, one can prepare for a future that is less mysterious. In most cases, one generalizes relationships between events or things as forecasts. In other cases, one projects trends. It is assumed that descriptions of the past will hold in the future.

To forecast the future, one needs to create or to find a pattern that links some set of events (cues—like the color of the water) to some other events (expectations—like the flooding of the lower river) with a general rule—if the water is clear, the flooding will be mild and late. Observing the cue, the rule produces the expectation, provided any constrictions were met. If that pattern is justified on the basis of past experience, then it can be applied and be used in the future. Downstream, the planting of crops to coincide with the late floods can be accommodated. The only wrinkle is that the conditions and environment changed and over time, the forecast is more likely to fail. That is, because of the many changes in the flora, geography and water flow of the Nile that altered outcomes.

The invention offers then a set of tools to organize and to improve management of knowledge, information and data, as well as computational intelligence. For each type of tool, a set of specifications that will enable assessing risk in using them and an agendum for improvement is supplied. A technique for selecting the best type of knowledge for a given task, for fitting that knowledge to an appropriate situation and for testing before use is provided. The tools and techniques will result in more reliable knowledge, better knowledge management and enhanced computational intelligence.

By selecting and labeling certain thinking processes and organizing same into a schema of abstractions, knowledge and information can be more useful. The system is simple, and novel. It takes effort to break old habits and learn new ones. The system can be tailored to individual needs and purposes.

The invention, known as ASK™ (Applied Systemic Knowledge), gives users tools and processes to manage knowledge, information and data into useful pieces. If one knows how one wants to use knowledge, ASK™ tools can reveal what types of patterns are needed, how to create them, and how to pre-test them before acting. In the case of failure, ASK™ tools can help find flaws in the knowledge base and fix them. ASK™ also provides a set of terms that aids in sharing information so that organizations can more effectively create, improve, and use knowledge.

ASK™ is a system for managing knowledge, information, and data based on the practices of successful research. ASK™ breaks down thinking processes into purposes, tools, and a taxonomy that can improve any effort to produce knowledge to guide action. ASK™ is a learnable system that is user friendly. The tools, terms, and processes can be practiced quickly to guide the design of recording, retrieving, and evaluating knowledge. ASK™ will help discover what types of knowledge patterns are needed. ASK™ will show how to create the patterns, seek the information necessary to estimate the risk of using them and pre-test them before use.

Knowledge can mean many things to many people, but the knowledge that ASK™ can help manage consists of the patterns necessary to successful action. In this limited sphere, knowledge can fulfill three basic purposes—anticipate what will happen, make things happen and decide on what is to happen. Four basic patterns or tools—categories, forecasts, causal theories and decision matrices—will meet those purposes. Each tool has its own formal characteristics, limitations and information demands. ASK™ tools demystify epistemology so one can find flaws and fix them, share evidence, and effectively create, improve, evaluate and use knowledge.

The invention presents a novel system and method to use results, particularly errors, to improve the reliability of knowledge. The system defines knowledge as patterns generalized from experience. When observed information is combined with a pattern, one can calculate possible results. When the pattern is applied, one can compare the actual results with the predicted results, and use that information to improve existing patterns, create new patterns, and refine estimates of the reliability of patterns. This process is referred to as the knowledge application process (“the Process”).

Thus in one embodiment, the system gives one the ability to:
(1) label the patterns, specify their components, describe the process of creation, evaluation, application, and improvement,
(2) seek the relevant data and information required to justify the pattern,
(3) specify the formal characteristics of each pattern to aid in recognizing, creating or improving them, and
(4) store information and data in forms that make it feasible and easier to estimate reliability.

The invention separates the Process into four basic patterns. Each pattern has a basic structure of components and requirements. The invention provides the following:

A method to improve the accuracy of the Process by taking the following steps:
(a) select a type of task in a given situation that requires knowledge;
(b) find the appropriate pattern(s) for that task;
(c) assume the pattern fits the situation;
(d) combine the pattern with an observation and calculate the result;
(e) estimate the reliability of the pattern based on past applications and estimate the accuracy of the diagnosis of the situation;
(f) apply the pattern and compare the actual result to the calculated result; and
(g) if the result does not match the calculated result, then examine
(i) the pattern and (ii) the diagnoses of the situation and proceed to reformulate either to improve results.

In another embodiment, the invention provides a method to identify the types of tasks for which individuals can use the Process, such as,
(a) to anticipate future events or conditions,
(b) to produce or inhibit change, and
(c) from a range of available courses of action, to select the action
most likely to improve specified conditions of life.

When the Process is used to anticipate the future, the appropriate pattern is referred to as a Forecast or a Classification.

When the Process is used to produce or inhibit change, the appropriate pattern is referred to as a Producer.

When the Process is used to select from a range of available courses of action, the action most likely to improve specified conditions of life, the appropriate pattern is referred to as a Decision Schema.

For each pattern, the component consists of (i) a variable at a particular value or range of values, or (ii) a group of variables with a set of corresponding values or ranges of values. For clarity and brevity, the claims treat all components as though they only consist of one variable with one value. However, the claims hold true when the component consists of (i) a variable with a range of values or (ii) a group of variables with a set of corresponding values or ranges of value

The invention provides a method that defines a description as a statement of what is observed (objects, events, or relations) at a specific time and place.

The invention provides a method which defines information as descriptions of objects and events at a certain time and place using categories.

Also provided is a method which defines knowledge as generalized patterns of relationships or characteristics of classes assumed to hold without regard to time and place; data as numbers and images of objects and events observed at a certain time and place; and category as a generalized pattern consisting of common characteristics, indicators, and a meaning.

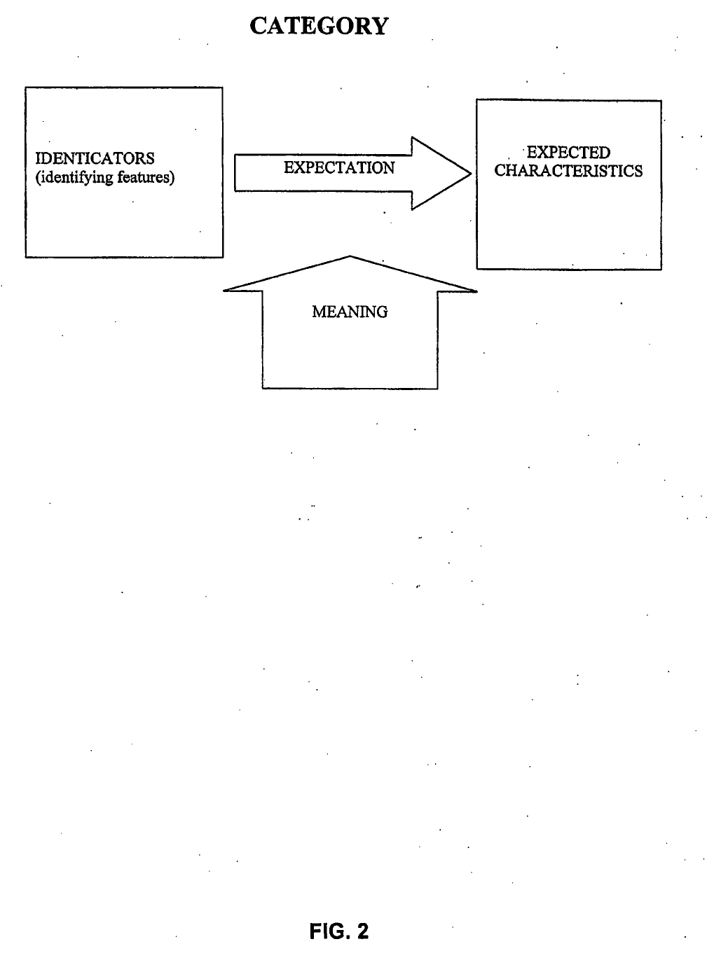

In the context of the invention, a category (FIG. 2) consists of the following components:
(a) a generalized set of characteristics common to all members;
(b) indicators, which are a subset of easily observed common characteristics to be used for identifying a particular thing or event as a member of the category;
(c) a meaning that connects the common characteristics to related patterns of human experience and semantic expressions; and
(d) a set of common characteristics, plus indicators, and a meaning constitutes the definition of a category.

The invention also provides a method for anticipating the future by identifying a member of a category and deducing the other common characteristics.

To anticipate using a category one must:

(a) identify a member of a category using indicators, and

(b) deduce any other common characteristics of the category.

An example is
(a) That X is gray with a bill more than fourteen inches long with an expandable pouch.
(b) Those indicators identify a member of the category, “pelican.”
(c) A pelican is a bird that feeds on fishes in saltwater environments by flying over the water, spotting fish, and diving to seize prey and carry it to their young in their expandable beaks.
(d) Since X is a member of the category it has all the common characteristics.
(e) Therefore anticipate that X will eat fish, fly, dive and live near salt water.

To assess the risk involved in assuming that a particular item has the characteristics of a particular category, one must examine the quantity and quality of (1) evidence that supports the category meaning, and (2) the observations made to conclude that the item possessed the indicators.

The invention provides a method to improve on the reliability of a category by using errors (meaning the deduction that a particular item possess the characteristics of a category is incorrect) to reexamine the category and determine whether the category meaning must be modified also is disclosed.

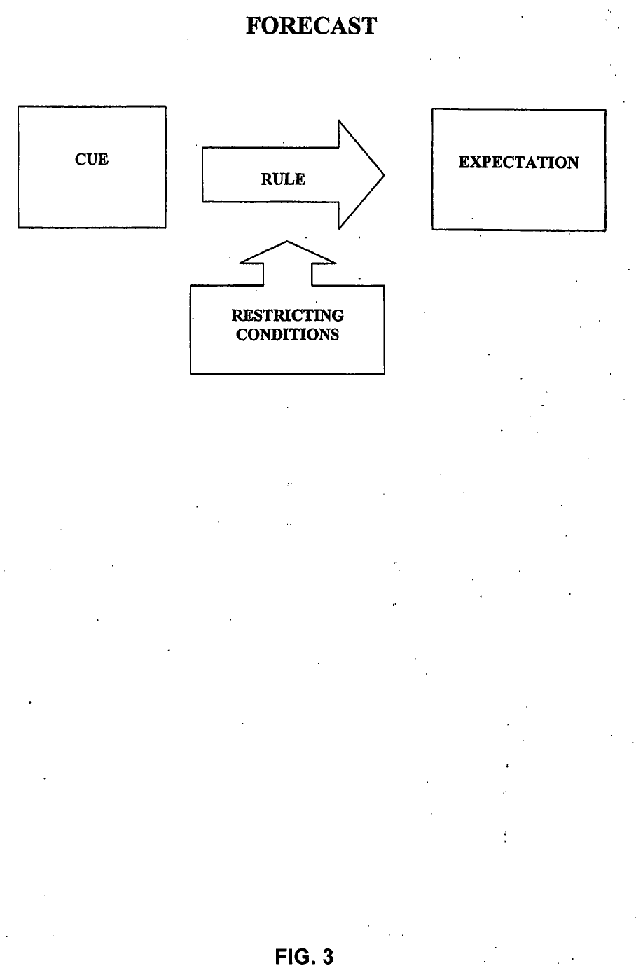

The forecast (FIG. 3) consists of the following components:

(a) a cue,

(b) an expectation,

(c) a rule, and

(d) restricting conditions.

A cue is an observable value of a variable. A rule is a statement of a non-causal relationship between two variables. An expectation is the predicted value of a variable.

In another embodiment, the invention discloses a method that defines restricting conditions as a prescribed set of values for variables that must be met to apply the forecast. Rules will become less accurate over time. The restricting conditions will reflect the historical conditions, which are necessary for the accuracy of the rule.

To apply a forecast one must:
(a) assume the selected forecast fits the observed situation;
(b) observe the value of the variable designated by the cue;
(c) observe the values of the variables designated by the restricting conditions;
(d) if the values of the variables fit the component requirements for the cue, rule, and restricting conditions, use the rule to calculate the value of the expectation component;
(e) examine the supporting information and data—the track record of previous applications of the forecast and estimate reliability;
(f) apply the pattern, and in time compare the expected values of the variables with those that actually occur;
(g) on that basis, reject, retain or reformulate the Forecast for future applications.

To assess the risk involved in assuming that the value of the expectation variable generated in applying a forecast will be correct, one must examine the quantity and quality of evidence that supports the rule and any historical conditions on which the rule may depend.

In another embodiment is provided a method to improve on the reliability of a forecast by using errors to re-examine the forecast and determine:
(a) whether the categories represented by the cue and expectation variables could be expanded or contracted to increase the reliability of the pattern,
(b) whether a different rule will provide more accurate results,
(c) whether the information used to support the rule is accurate, and
(d) whether likely changes in historical conditions may invalidate the rule.

The Producer consists of the following components:

(a) an action,

(b) a driver,

(c) restrictions, and

(d) a target.

An action is defined as a variable the value of which an actor can change by taking one or more steps. A driver is a statement, which expresses a causal relationship between the change in value of one variable (the action) with the change in the value of a second variable (the target). Restrictions are a prescribed set of values for variables under which the driver will be inaccurate. Under these circumstances, the driver is invalid or the causal relationship contained in the driver will be weaker or stronger than stated.

In yet another embodiment, a method that defines a target as a variable that will change value as a result of the change of value of the action variable is provided.

To apply a Producer, one must:
(a) identify the target variable and value the actor seeks to obtain;
(b) identify a causal relationship between the target's value and the value of a variable that the actor can directly or indirectly change;
(c) determine whether any restrictions exist under which the relationship expressed in the driver would be altered (weaker or stronger than expressed) or invalid;
(d) if the restrictions invalidate the driver, repeat steps (b) and (c);
(e) use the driver and any relevant restrictions to calculate what value the action variable must be in order to obtain the target desired value;
(f) apply the producer by taking the steps necessary to change the value of the action variable to that calculated in step (e);
(g) in time, compare the expected values of the variables with those that actually occur; and
(h) on that basis, reject, retain or reformulate the producer for future application.

To assess the risk involved in assuming that the value of the target will be the expected value, the quantity and quality of the information used to derive the driver and identify the restrictions must be examined.

The invention provides a method to improve on the reliability of a producer by using errors (meaning that the anticipated value of the target differs from what actually occurs) to re-examine the producer and determine:
(a) whether the categories represented by the action, the target, and the restrictions could be expanded or contracted to increase the reliability of the pattern,
(b) whether a different driver will provide more accurate results,
(c) whether the information used to derive the driver and the restrictions is accurate, and
(d) whether additional restrictions must be considered.

In the context of the instant invention, the Decision Schema pattern consists of the following components:

(a) options,

(b) generators,

(c) inputs,

(d) attributes,

(e) buffers,

(f) preferences,

(g) directives, and a

(h) procedure.

An option is a set of inputs available to an actor who takes a specified course of action at a specific time and place. An input is a characteristic of an option, a variable. For example, if someone was trying to choose between two restaurants, ambiance, breadth of menu, and price would be inputs. A generator is a causal pattern linking changes in the value of an input to resulting changes in the value of an attribute. An attribute is an aspect of life that is esteemed, such as health, freedom, security and wealth, the value of which is causally linked to the value of one or more inputs. A buffer is a condition of a person or population that affects how much or how little a change in the value of an input will result in a change in the value of an attribute. A procedure is a recipe (a list of the actions necessary) for producing a set of inputs, the values of which, meet the requirements of a specified directive. A preference is a statement comparing the desirability of the options studies. It should take the form of, “prefer this set of values for this set of attributes over those set of values for the same set of attributes.” A directive is a generalized preference. It takes the form of, “when deciding among these options under these conditions (buffers) always select these values for these attributes over any other set of the values for these attributes.”

The invention also provides a method for improving the quality of decisions by taking the following steps:
(a) select one or more available options;
(b) select a limited set of attributes of a human life or lives such as health, freedom, security, and wealth, that must be maintained or improved according to the emotional commitments of an individual or community;
(c) select the inputs of which a change in value of the variable will change the value of one or more of the attributes selected in step (b);
(d) select the set of buffers (conditions of individuals or communities) that will affect the magnitude of the change of the value of the inputs on change in the value of the attributes;
(e) project the values of the attributes for each option by applying the relevant generator and buffers;
(f) comparing the values of the attributes for each option as a whole select the optimal set of attributes;
(g) express that comparison in a preference of the form—prefer this set of values for this set of attributes over those values for this set of attributes;
(h) generalize the preference into a directive of the form, “when deciding among these options under these conditions (buffers) always select these values for these attributes”;
(i) find or create a procedure to produce a set of inputs that will generate the values of the attributes contained in the directive provided in step (h);
(j) review evidence for and reliability assumed in the projections of steps (e) and (f) in order to estimate the risks involved in adopting the generalized preference in step (h);
(k) review current information about other options you may want to consider;
(l) if the review (steps (j) and (k)) requires revisions, revise the weaker components (such as consider additional options or additional attributes) until satisfied that the risk in moving forward with making the decision is acceptable;
(m) carry out the procedure identified in step (i);
(n) if the inputs do not result after carrying out the procedure, then revise the procedure;
(o) if the inputs do result after carrying out the procedure, then compare the values of the attributes with the projected values and if they fall short reformulate the underlying generators and buffers identified in step (e); and
(p) if the values of the attributes match the projection but the state of affairs is not acceptable (the decision maker is unhappy with his or her decision) then reformulate the directive of step (h).

The heuristic method taught herein can be applied directly by individuals or is amenable to an information processing means. Hence, in the case of the latter embodiment, the system disclosed herein is reduced to a series of steps or commands which are executed by a processing means. The various categories taught herein each can comprise a module comprising a data storage means for the input of information needed to execute the subroutine of a particular module. The data storage means is as known in the art as, for example, a diskette, a tape, a RAM, a ROM, a flash drive and so on. The processing means can comprise a central processing unit along with suitable input means and output means, such as a keyboard and a monitor or printer, for example, respectively.

The processing means can comprise communication means to integrate with other data storage means or processing means. Connectivity to externals is as known in the art. See, for example, U.S. Pat. Nos. 5,933,818 and 6,470,277.

A data reduction is known in the art, and there are many computational tools to obtain a taxonomy of subsets or hierarchical nesting of groupings of relatedness wherein generalized features common to all or many members of a set or subset are obtained to derive a subset, see for example the '818 patent noted hereinabove and U.S. Pat. No. 7,020,688.

A processor means can determine relatedness using preselected parameters for comparisons, as known in the art, see, for example, U.S. Pat. Nos. 6,277,567; 6,442,743; 6,556,992; and 6,754,660. Relatedness is related to taxonomy, sytematics and classification schemes, wherein common features are deduced to reveal relationships between and among individuals, items or events, and between and among subsets or groups of individuals, items or events.

A number of parameters can be manipulated by the user. Some parameters are disclosed herein. Other are those available in any data analysis, such as significance, confidence limits, standard deviation, parametric analysis and the like.

Thus, a code can be written to execute the various methods taught herein, such as those recited herein or depicted in the block diagrams to obtain a means of automatically computing the various inputted information to obtain a desired result as provided herein.

It should be understood that various changes and modifications to the presently preferred embodiments described herein will be apparent to those skilled in the art. Such changes and modifications can be made without departing from the spirit and scope of the present invention and without diminishing its intended advantages. It is therefore intended that such changes and modifications be covered by the appended claims.

All references cited herein are herein incorporated by reference in entirety.

What is claimed is:

1. A computational intelligence system comprising:
a. a storage means;
b. a processing means; and
c. a pattern comparing means,
wherein said storage means comprises hierarchical organizations of data and data reductions, wherein a data reduction reduces the data or a reduced data subset into a higher order subset, wherein a pattern comprises a higher order subset, and wherein said pattern comparing means determines the relatedness of a selected pattern with a data query of an item or event by comparing a calculated outcome with the actual outcome.

2. The system of claim 1, wherein said data query comprises one or more indicators characterizing said item or event, wherein said pattern comparing means compares said one or more indicators to said patterns to identify the pattern with the greatest relatedness to said indicators, and wherein said identified pattern predicts properties of said item or event of said data query.

3. The system of claim 1, wherein said pattern comparing means provides an ordered list of patterns ranked by relatedness.
